(19) United States
(12) Patent Application Publication
(10) Pub. No.: US 2018/0290150 A1
(43) Pub. Date: Oct. 11, 2018

(54) HIGH SPEED SHATTERPROOF CONTAMINATION PROOF REFRIGERATED CENTRIFUGE FOR CELL EXTRACTION

(71) Applicant: Siu Hang CHENG, Hong Kong (HK)

(72) Inventor: Siu Hang CHENG, Hong Kong (HK)

(21) Appl. No.: 15/598,266

(22) Filed: May 17, 2017

(30) Foreign Application Priority Data
Apr. 7, 2017 (CN) 201710026999.5

(51) Int. Cl. B04B 5/04; B04B 13/00; B04B 15/02; B04B 7/16; B04B 15/08

(52) U.S. Cl. CPC B04B 5/0414; B04B 13/00; B04B 15/08; B04B 7/16; B04B 15/02

(57) ABSTRACT

The present invention relates to a high speed shatterproof contamination proof refrigerated centrifuge for cell extraction, comprising a housing, a central console disposed inside a chamber of the housing, a refrigerating mechanism disposed inside the housing, a separation mechanism, a pair of roll wheels disposed at a bottom of the housing and a shatterproof recollection device; a ring shaped working sink for installing the separation mechanism is disposed at a top wall of the housing; a ventilation hole and a control panel is disposed at two sides of the housing respectively; the separation mechanism comprises a centrifuge rotor disposed inside the ring shaped working sink and a rotational motor for driving the centrifuge rotor. The high speed shatterproof contamination proof refrigerated centrifuge for cell extraction of the present invention has the advantages of having a simple structure, sensible design, high rotational speed, and having refrigerating, angle adjustment and shatterproof recollection features. The high speed refrigerating centrifuge can also satisfy a higher requirement of material separation, refinement and purification.

### FIELD OF INVENTION

The present invention relates to the field of cell testing equipment, in particular to a high speed shatterproof contamination proof refrigerated centrifuge for cell extraction.

### BACKGROUND OF INVENTION

Centrifuges are machines that separates samples that are widely used in the field of biomedical science. They make use of the difference in sedimentation speed of different materials in centrifugal field to achieve analytical separation of samples. Since its invention, centrifuges have gone through low speed, adjustment and ultraspeed eras, with the development generally in the fields of centrifuge equipment and centrifugation technology. Cell centrifuges on the market today generally belongs to the low speed, high speed type, therefore having the technical characteristics of both low speed and high speed centrifuges. However, in biopharmaceutical companies, a high requirement is needed for the centrifuge for production and research of clinical and biological experiments. Especially, a strong centrifugal force and an environment relatively suitable for the existence of bacteria and microorganisms is needed when separating these, for the purpose of clinical and biological experiments.

### SUMMARY OF INVENTION

The technical problem to be solved by the present invention is: to overcome the aforementioned problem, a high speed shatterproof contamination proof refrigerated centrifuge for cell extraction is provided. The centrifuge has the advantages of having a simple structure, sensible design, high rotational speed, and having refrigerating, angle adjustment and shatterproof recollection features. The high speed refrigerating centrifuge can also satisfy a higher requirement of material separation, refinement and purification.

The technical solution used in the present invention to solve the technical problem is: a high speed shatterproof contamination proof refrigerated centrifuge for cell extraction, comprising a housing, a central console disposed inside a chamber of the housing, a refrigerating mechanism disposed inside the housing, a separation mechanism, a pair of roll wheels disposed at a bottom of the housing and a shatterproof recollection device; a ring shaped working sink for installing the separation mechanism is disposed at a top wall of the housing; a ventilation hole and a control panel is disposed at two sides of the housing respectively; the separation mechanism comprises a centrifuge rotor disposed inside the ring shaped working sink and a rotational motor for driving the centrifuge rotor; the centrifuge rotor comprises a holding plate drivably connected to the rotational motor, a number of positioning buckles disposed along a top of the holding plate, a number of test tubes disposed on the positioning buckles and an adjustment mechanism conjugate to the tail end of the test tube for adjusting the centrifugation angle.

The adjustment mechanism comprises a curved adjustment slot with a slide rail disposed at two side walls thereof, a holder disposed inside the curved adjustment slot for cupping to the tail end of the test tube, and compression springs disposed respectively in the curved structure between two sides of the stand and the end surfaces of the curved adjustment slot; ears for movingly latching to the slide rail is disposed at the two sides of the holder.

The shatterproof recollection system comprises a protection net disposed at a bottom of the separation mechanism, a filter paper disposed on top of the protection net, and a recollection box disposed exterior to the ring shaped working sink and linked therewith; guide flowing surfaces sloping outwards are disposed at a bottom surface of the ring shaped working sink; a through hole linked to the recollection box is disposed at a bottom surface of the ring shaped working sink.

In a preferred embodiment, a positioning bolt is disposed at a bottom of the stand; a number of positioning slots latched to the mounting bolts is disposed at a bottom of the curved adjustment slot.

In a preferred embodiment, the positioning buckles comprises 6 to 12 buckles.

In a preferred embodiment, the refrigerating mechanism comprises a refrigerating device mounted on the housing and a dust filter disposed on the ventilation hole; the refrigerating device is wired to the central console.

In a preferred embodiment, the touch panel is wired to the central console; the central console is connected to an external power source.

The advantage of the present invention is: the high speed shatterproof contamination proof refrigerated centrifuge for cell extraction of the present invention, by sending a signal to the central console through the touch panel, the central console powers up the rotational motor and the refrigerating device independently by identifying the instruction. The refrigerating device when powered up will refrigerate to produce an environment suitable for living of the cell. The rotational motor when powered up will spin the separation mechanism to separate cells through centrifugal force. The centrifuge rotor is further provided with an adjustment mechanism, can adjust centrifugation angle depending on rotating speed or adjust the test tube angle in a fixed manner, increasing efficiency, reducing load of the test tube, prolonging life of the test tube. The high speed refrigerating centrifuge can also satisfy a higher requirement of material separation, refinement and purification.

### BRIEF DESCRIPTION OF DRAWINGS

The present invention is further explained below with the accompanying drawings and embodiments.

FIG. 1 is an overall structural schematic diagram of a high speed shatterproof contamination proof refrigerated centrifuge for cell extraction according to the present invention.

FIG. 2 is a structural schematic diagram of a centrifuge rotor of a high speed shatterproof contamination proof refrigerated centrifuge for cell extraction according to the present invention.

FIG. 3 is a structural schematic diagram of a shatterproof recollection device of a high speed shatterproof contamination proof refrigerated centrifuge for cell extraction according to the present invention.

FIG. 4 is a structural schematic diagram of an adjustment mechanism of a high speed shatterproof contamination proof refrigerated centrifuge for cell extraction according to the present invention.

FIG. 5 is a structural schematic diagram of a holder of a high speed shatterproof contamination proof refrigerated centrifuge for cell extraction according to the present invention.

Reference numbers in the drawings: 1 housing, 11 chamber, 12 ring shaped working sink, 121 flow guiding surface, 122 through hole, 13 ventilation hole, 14 touch panel, 2 roll wheel, 3 refrigerating mechanism, 31 refrigerating device, 32 dust filter, 4 centrifuge rotor, 41 rotational motor, 44 holding plate, 45 positioning buckle, 46 test tube, 461 holder, 462 ear, 463 positioning bolt, 47 curved adjustment slot, 471 slide rail, 472 compression spring, 473 positioning slot, 5 central console, 6 protection net, 61 filter paper, 62 recollection box.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

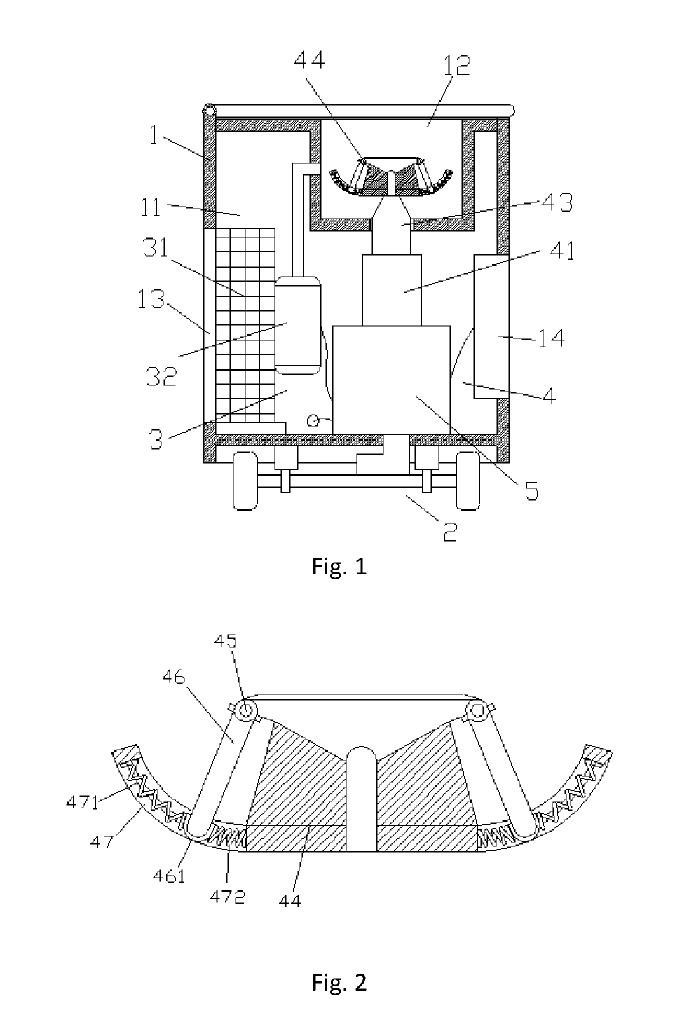

A high speed shatterproof contamination proof refrigerated centrifuge for cell extraction is shown in FIG. 1. The centrifuge comprises a housing 1, a central console 5 disposed inside a chamber of the housing 1, a refrigerating mechanism 3 disposed inside the housing 1, a separation mechanism, a pair of roll wheels 2 disposed at a bottom of the housing 1 and a shatterproof recollection device. A ring shaped working sink 12 for installing the separation mechanism is disposed at a top wall of the housing 1. A ventilation hole 13 and a control panel 14 is disposed at two sides of the housing 1 respectively. The separation mechanism comprises a centrifuge rotor 4 disposed inside the ring shaped working sink 12 and a rotational motor 41 for driving the centrifuge rotor 4. The centrifuge rotor 4 comprises a holding plate 44 drivably connected to the rotational motor 41, a number of positioning buckles 45 disposed along a top of the holding plate 44, a number of test tubes 46 disposed on the positioning buckles 45 and an adjustment mechanism conjugate to the tail end of the test tube 46 for adjusting the centrifugation angle. The positioning buckles comprises 6-12 buckles. The refrigerating mechanism 3 comprises a refrigerating device 31 mounted on the housing 11 and a dust filter 32 disposed on the ventilation hole 13. The refrigerating device 31 is wired to the central console 5. The touch panel 14 is wired to the central console 5. The central console 5 is connected to an external power source.

In a high speed shatterproof contamination proof refrigerated centrifuge for cell extraction as shown in FIG. 2, the adjustment mechanism comprises a curved adjustment slot 47 with a slide rail 471 disposed at two side walls thereof, a holder 461 disposed inside the curved adjustment slot 47 for cupping to the tail end of the test tube 46, and compression springs 472 disposed respectively in the curved structure between two sides of the stand 461 and the end surfaces of the curved adjustment slot 47. Ears 462 for movingly latching to the slide rail 471 is disposed at the two sides of the holder 461.

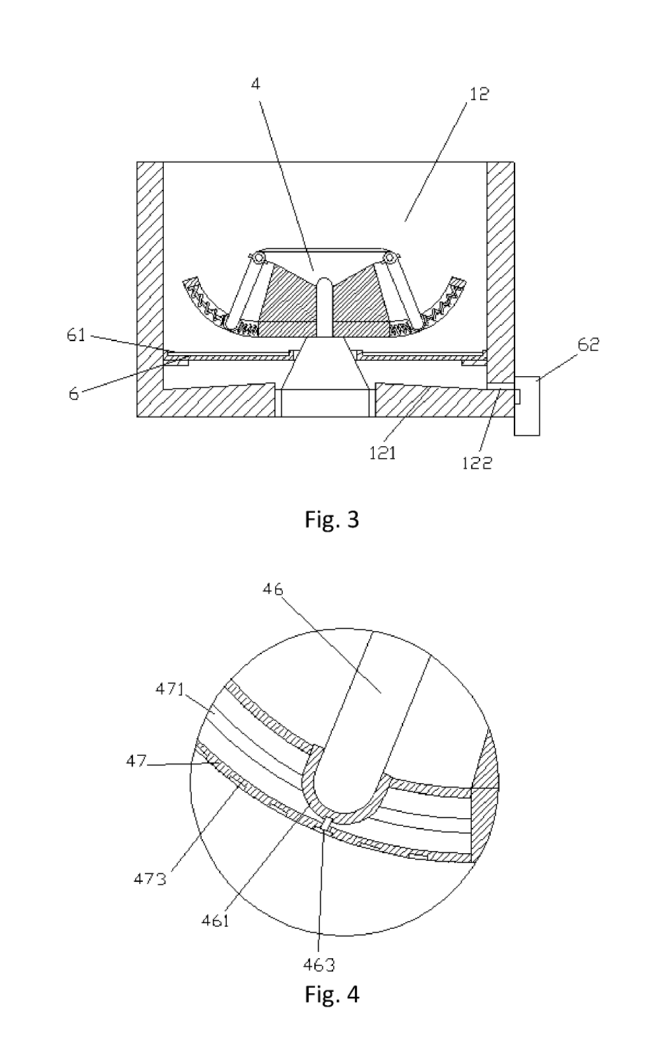

In a high speed shatterproof contamination proof refrigerated centrifuge for cell extraction as shown in FIG. 3, the shatterproof recollection system comprises a protection net 6 disposed at a bottom of the separation mechanism, a filter paper 61 disposed on top of the protection net 6, and a recollection box 62 disposed exterior to the ring shaped working sink 12 and linked therewith. Guide flowing surfaces 121 sloping outwards are disposed at a bottom surface of the ring shaped working sink 12. A through hole 122 linked to the recollection box 62 is disposed at a bottom surface of the ring shaped working sink 12.

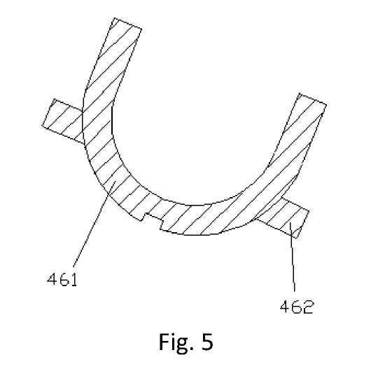

In a high speed shatterproof contamination proof refrigerated centrifuge for cell extraction as shown in FIGS. 4-5, a positioning bolt 463 is disposed at a bottom of the stand 461. A number of positioning slots 473 latched to the mounting bolts 463 is disposed at a bottom of the curved adjustment slot 47.

The high speed shatterproof contamination proof refrigerated centrifuge for cell extraction of the present invention, by sending a signal to the central console 5 through the touch panel 14, the central console 5 powers up the rotational motor 41 and the refrigerating device 31 independently by identifying the instruction. The refrigerating device 31 when powered up will refrigerate to produce an environment suitable for living of the cell. The rotational motor 41 when powered up will spin the separation mechanism to separate cells through centrifugal force. The centrifuge rotor is further provided with an adjustment mechanism, can adjust centrifugation angle depending on rotating speed or adjust the test tube angle in a fixed manner, increasing efficiency, reducing load of the test tube 46, prolonging life of the test tube. The high speed refrigerating centrifuge can also satisfy a higher requirement of material separation, refinement and purification.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. A high speed shatterproof contamination proof refrigerated centrifuge for cell extraction, comprising: a housing, a central console disposed inside a chamber of the housing, a refrigerating mechanism disposed inside the housing, a separation mechanism, a pair of roll wheels disposed at a bottom of the housing and a shatterproof recollection device; a ring shaped working sink for installing the separation mechanism is disposed at a top wall of the housing; a ventilation hole and a control panel is disposed at two sides of the housing respectively; the separation mechanism comprises a centrifuge rotor disposed inside the ring shaped working sink and a rotational motor for driving the centrifuge rotor; the centrifuge rotor comprises a holding plate drivably connected to the rotational motor, a number of positioning buckles disposed along a top of the holding plate, a number of test tubes disposed on the positioning buckles and an adjustment mechanism conjugate to the tail end of the test tube for adjusting the centrifugation angle;
the adjustment mechanism comprises a curved adjustment slot with a slide rail disposed at two side walls thereof, a holder disposed inside the curved adjustment slot for cupping to the tail end of the test tube, and compression springs disposed respectively in the curved structure between two sides of the stand and the end surfaces of the curved adjustment slot; ears for movingly latching to the slide rail is disposed at the two sides of the holder;
the shatterproof recollection system comprises a protection net disposed at a bottom of the separation mechanism, a filter paper disposed on top of the protection net, and a recollection box disposed exterior to the ring shaped working sink and linked therewith; guide flowing surfaces sloping outwards are disposed at a bottom surface of the ring shaped working sink; a through hole linked to the recollection box is disposed at a bottom surface of the ring shaped working sink.

2. The high speed shatterproof contamination proof refrigerated centrifuge for cell extraction according to claim 1, characterized in that: a positioning bolt is disposed at a bottom of the stand; a number of positioning slots latched to the mounting bolts is disposed at a bottom of the curved adjustment slot.

3. The high speed shatterproof contamination proof refrigerated centrifuge for cell extraction according to claim 1, characterized in that: the positioning buckles comprises 6 to 12 buckles.

4. The high speed shatterproof contamination proof refrigerated centrifuge for cell extraction according to claim 1, characterized in that: the refrigerating mechanism comprises a refrigerating device mounted on the housing and a dust filter disposed on the ventilation hole; the refrigerating device is wired to the central console.

5. The high speed shatterproof contamination proof refrigerated centrifuge for cell extraction according to claim 1, characterized in that: the touch panel is wired to the central console; the central console is connected to an external power source.
